(19) United States
(12) Patent Application Publication
(10) Pub. No.: US 2008/0121324 A1
(43) Pub. Date: May 29, 2008

(54) Tire Running Thread

(76) Inventors: Stephanie Cambon, Chamalieres (FR); Didier Vasseur, Clermont-Ferrand (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/795,614

(22) PCT Filed: Jan. 16, 2006
(86) PCT No.: PCT/EP06/00306

§ 371 Date: Jul. 19, 2007

(30) Foreign Application Priority Data
Sep. 19, 2005 (FR) 0500568

(51) Int. Cl. B60C 1/00; B29C 35/08; B29C 47/00

(52) U.S. Cl. 152/209.1; 264/175; 264/176.1; 264/464

(57) ABSTRACT

Tire tread comprising a rubber composition based on at least a diene elastomer, a nonblack reinforcing filler, in particular inorganic filler, and a coupling agent providing the bonding between the diene elastomer and said filler, said composition being characterized in that it additionally comprises a prophoto-oxidizing agent and optionally carbon black at a level of less than 5 phr (parts by weight per hundred parts of elastomer). The prophoto-oxidizing agent is in particular a photo-initiator of radical or cationic type, which may or may not be activated by the presence of a photosensitizer.

The tires comprising such a tread exhibit, after photo-oxidation (exposure to UV-visible radiation) of said tread, a significant increase in the grip on a wet road.

The present invention relates to tire treads comprising rubber compositions reinforced by a nonblack filler, in particular an inorganic filler, such as silica.

It relates more particularly to treads reinforced majoritarily by a nonblack filler and optionally comprising a minor amount of carbon black.

As is known, a tire tread has to meet a large number of often conflicting technical requirements, including a low rolling resistance, a high wear resistance and a high grip, in particular on wet or damp road.

These compromises of properties, in particular from the viewpoint of the rolling resistance and the wear resistance, were able to be improved in recent years with regard to energy-saving Green Tires, intended in particular for passenger vehicles, by virtue of the use of new rubber compositions of low hysteresis having the characteristic of being reinforced majoritarily by specific inorganic fillers, referred to as reinforcing fillers, such as highly dispersible silicas (HDS), capable of rivaling, from the viewpoint of the reinforcing ability, conventional tire-grade carbon blacks.

Thus, today, the reinforcing inorganic fillers are gradually replacing conventional carbon blacks in tire treads, all the more so as they have another known virtue, that of increasing the grip of tires on wet, snowy or icy roads. However, the use of carbon black at a low level, typically within a ratio of 5 to 10 or 20 phr, is continued; within the ranges indicated, it is known that it is possible to benefit from the coloring (black pigmenting agent) and UV-stabilizing properties of carbon blacks without, moreover, penalizing the typical performances introduced by the reinforcing inorganic filler, namely low hysteresis and improved grip on wet, snowy or icy ground. Mention will be made, to illustrate the state of the art, for example, of the patents or patent applications FR 2 797 636 (or GB 2 354 246), EP 0 890 606, EP 1 092 565, US20020151640, WO 01/96442, WO 02/10269, WO 02/22728, WO 02/31041, WO 02/053634, WO 02/066519, WO 02/083782, WO 03/002648 and WO 03/002649.

The enhancement in the grip properties of tires, even for treads reinforced with a reinforcing inorganic filler, remains, however, a constant preoccupation of designers of tires.

In point of fact, surprisingly, the Applicants have discovered that the grip on wet or damp ground can be further improved, without compromising the other properties mentioned above, by incorporating a prophoto-oxidizing agent in rubber compositions for treads reinforced with a nonblack filler, in particular an inorganic filler.

Consequently, a first subject matter of the invention relates to a tread comprising a rubber composition based on at least a diene elastomer, a nonblack reinforcing filler, a coupling agent providing the bonding between the diene elastomer and said filler, and optionally carbon black, said tread being characterized in that said composition additionally comprises a prophoto-oxidizing agent and in that its level of carbon black is zero or less than 5 phr (parts by weight per hundred parts of elastomer).

Another subject matter of the invention is the use of such a tread in the manufacture of new tires or the retreading of worn tires.

The tread in accordance with the invention is particularly suitable for tires intended to be fitted on motor vehicles of passenger-vehicle type, SUV (sport utility vehicles), two-wheeled vehicles (in particular bicycles, scooters or motor cycles), aircraft, and also industrial vehicles chosen, for example, from vans or “heavy-duty” vehicles (that is to say, subway, bus or heavy road transportation vehicles, such as trucks, tractors or trailers).

Another subject matter of the invention is these tires themselves, when they comprise a tread in accordance with the invention.

Another subject matter of the invention is a process for preparing a tire tread capable of exhibiting, after photo-oxidation of its surface, an improved grip on wet ground, this process being characterized in that there are incorporated in at least a diene elastomer, by kneading, at least a nonblack filler as reinforcing filler, a coupling agent intended to provide the bonding between the diene elastomer and said filler, optionally carbon black at a level of zero or less than 5 phr, a prophoto-oxidizing agent and a crosslinking system and in that the combined mixture is extruded in the form of a tread.

The invention and its advantages will be easily understood in the light of the description and exemplary embodiments which follow.

### I. MEASUREMENTS AND TEST USED

The treads and constituent rubber compositions of these treads are characterized, before and after curing, as indicated below.

### I-1. Mooney Plasticity

Use is made of an oscillating consistometer as described in French standard NF T 43-005 (November 1980). The Mooney plasticity measurement is carried out according to the following principle: the rubber composition in the raw state (i.e., before curing) is molded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 newton·meter).

### I-2. Tensile Tests

These tensile tests make it possible to determine the elasticity stresses and the properties at break. Unless otherwise indicated, they are carried out in accordance with French standard NF T 46-002 of September 1988. The nominal secant moduli (or apparent stresses, in MPa) are measured in second elongation (i.e., after a cycle of accommodation to the degree of extension anticipated for the measurement itself) at 10% elongation (recorded as M10), 100% elongation (recorded as M100) and 300% elongation (recorded as M300).

The breaking stresses (in MPa) and elongations at break (in %) are also measured. All these tensile measurements are carried out under standard conditions of temperature (23±2° C.) and humidity (50±5% relative humidity), according to French standard NF T 40-101 (December 1979).

### I-3. Tests on Tires

### Braking on Wet Road

The tires are fitted to a motor vehicle equipped with an ABS braking system and the distance necessary to change from 50 km/h to 10 km/h upon sudden braking on a wet ground (asphalt concrete) is measured. A value greater than that of the control, arbitrarily set at 100, indicates an improved grip, that is to say a shorter braking distance.

### II. DETAILED DESCRIPTION OF THE INVENTION

The treads according to the invention are formed, at least for their surface part intended to come into contact with the road, of a rubber composition based on at least: (i) a (at least one) diene elastomer; (ii) a (at least one) nonblack filler, in particular an inorganic filler, as reinforcing filler; (iii) a (at least one) coupling agent providing the bonding between said reinforcing filler and the diene elastomer; (iv) a (at least one) prophoto-oxidizing agent; and optionally carbon black at a level of less than 5 phr, preferably of less than 3 phr.

Of course, the expression composition “based on” should be understood to mean a composition comprising the mixture and/or the in situ reaction product of various constituents used, some of these base constituents (for example, the coupling agent and the reinforcing filler) being capable of reacting or intended to react together, at least in part, during the various phases of manufacture of the treads, in particular during their vulcanization (curing).

In the present description, unless expressly indicated otherwise, all percentages (%) shown are % by weight.

### II-1. Diene Elastomer

The term “diene” elastomer (or synonym rubber) is understood generally to mean an elastomer resulting at least in part (i.e., a homopolymer or copolymer) from diene monomers (monomers bearing two carbon-carbon double bonds which may or may not be conjugated).

Diene elastomers, in a known way, can be classified into two categories: those said to be “essentially unsaturated” and those said to be “essentially saturated”. The term “essentially unsaturated” diene elastomer is understood to mean a diene elastomer resulting at least in part from conjugated diene monomers having a level of units of diene origin (conjugated dienes) which is greater than 15% (mol %). Thus it is, for example, that diene elastomers such as butyl rubbers or copolymers of dienes and of α-olefins of EPDM type do not come within this definition and can be described, on the contrary, as “essentially saturated” diene elastomers (low or very low level of units of diene origin, always less than 15%). In the category of “essentially unsaturated” diene elastomers, the term “highly unsaturated” diene elastomer is understood to mean in particular a diene elastomer having a level of units of diene origin (conjugated dienes) which is greater than 50%.

Given these general definitions, the person skilled in the art of the tire will understand that the present invention is firstly implemented with highly unsaturated diene elastomers, in particular with:
(a) any homopolymer obtained by polymerization of a conjugated diene monomer having from 4 to 12 carbon atoms;
(b) any copolymer obtained by copolymerization of one or more conjugated dienes together or with one or more vinylaromatic compounds having from 8 to 20 carbon atoms.

The following are suitable in particular as conjugated dienes: 1,3-butadiene, 2-methyl-1,3-butadiene, 2,3-di[(C₁-C₅)alkyl]-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: stirene, ortho-, meta- or para-methylstirene, the “vinyltoluene” commercial mixture, para-(tert-butyl)stirene, methoxystirenes, chlorostirenes, vinylmesitylene, divinylbenzene or vinylnaphthalene.

The copolymers may contain between 99% and 20% by weight of diene units and between 1% and 80% by weight of vinylaromatic units. The elastomers may have any microstructure which depends on the polymerization conditions used, in particular on the presence or absence of a modifying and/or randomizing agent and on the amounts of modifying and/or randomizing agent employed. The elastomers may, for example, be block, random, sequential or microsequential blocks and may be prepared in dispersion or in solution; they may be coupled and/or star-branched or also functionalized with a coupling and/or star-branching or functionalization agent.

The following are preferably suitable: polybutadienes, in particular those having a content of 1,2-units of between 4% and 80% or those having a content of cis-1,4-units of greater than 80%, polyisoprenes, butadiene/stirene copolymers and in particular those having a stirene content of between 5% and 50% by weight and more particularly between 20% and 40%, a content of 1,2-bonds of the butadiene part of between 4% and 65% and a content of trans-1,4-bonds of between 20% and 80%, butadiene/isoprene copolymers and in particular those having an isoprene content of between 5% and 90% by weight and a glass transition temperature (“Tg”, measured according to ASTM D3418-82) of −40° C. to −80° C., or isoprene/stirene copolymers and in particular those having a stirene content of between 5% and 50% by weight and a Tg of between −25° C. and −50° C. In the case of butadiene/stirene/isoprene copolymers, those having a stirene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2-units of the butadiene part of between 4% and 85%, a content of trans-1,4-units of the butadiene part of between 6% and 80%, a content of 1,2-plus 3,4-units of the isoprene part of between 5% and 70% and a content of trans-1,4-units of the isoprene part of between 10% and 50%, and more generally any butadiene/stirene/isoprene copolymer having a Tg of between −20° C. and −70° C., are suitable in particular.

To sum up, the diene elastomer of the composition according to the invention is particularly preferably chosen from the group of the (highly unsaturated) diene elastomers consisting of polybutadienes (BR), synthetic polyisoprenes (IR), natural rubber (NR), butadiene copolymers, isoprene copolymers and the blends of these elastomers. Such copolymers are more preferably chosen from the group consisting of butadiene/stirene copolymers (SBR), isoprene/butadiene copolymers (BIR), isoprene/stirene copolymers (SIR), isoprene/butadiene/stirene copolymers (SBIR) and the blends of such copolymers.

The tread in accordance with the invention is preferably intended for a passenger vehicle tire. In such a case, the diene elastomer is preferably an SBR copolymer, whether prepared in solution (SSBR) or as an emulsion (ESBR), preferably used as a blend with a polybutadiene; more preferably, the SBR has a stirene content of between 20% and 30% by weight, a content of vinyl bonds of the butadiene part of between 15% and 65%, a content of trans-1,4-bonds of between 15% and 75% and a Tg of between −20° C. and −55° C., and the polybutadiene has more than 90% of cis-1,4-bonds.

In the case of a tire for a heavy-duty vehicle, the diene elastomer is preferably an isoprene elastomer, that is to say an isoprene homopolymer or copolymer, in other words a diene elastomer chosen from the group consisting of natural rubber (NR), synthetic polyisoprenes (IR), the various copolymers of isoprene or a blend of these elastomers. Mention will in particular be made, among isoprene copolymers, of isobutene/isoprene (butyl rubber—IIR) copolymers, isoprene/stirene (SIR) copolymers, isoprene/butadiene (BIR) copolymers or isoprene/butadiene/stirene (SBIR) copolymers. This isoprene elastomer is preferably natural rubber or a synthetic cis-1,4-polyisoprene; use is preferably made, among these synthetic polyisoprenes, of polyisoprenes having a level (mol %) of cis-1,4-bonds of greater than 90%, more preferably still of greater than 98%. For such a tire for a heavy-duty vehicle, the diene elastomer can also be composed, in all or part, of another highly unsaturated elastomer, such as, for example, an SBR elastomer.

The compositions of the treads of the invention may comprise a single diene elastomer or a blend of several diene elastomers, it being possible for the diene elastomer or elastomers to be used in combination with any type of synthetic elastomer other than a diene elastomer, indeed even with polymers other than elastomers, for example thermoplastic polymers.

### II-2. Nonblack Reinforcing Filler

“Nonblack reinforcing filler” should be understood here as meaning any inorganic filler, indeed even any organic filler other than carbon black, whatever its color and its origin (natural or synthetic), sometimes referred to as “mineral” filler, “white” filler or “clear” filler in contrast to carbon black, this nonblack filler being capable of reinforcing by itself alone, with no other means than an intermediate coupling agent, a rubber composition intended for the manufacture of a tire tread, in other words capable of replacing, in its reinforcing role, a conventional carbon black of tire grade for a tread; such a filler is generally characterized, in a known way, by the presence of functional groups, in particular hydroxyl functional groups, at its surface, thus requiring the use of a coupling agent intended to provide a stable chemical bond between the diene elastomer and said filler.

Preferably, the nonblack reinforcing filler is an inorganic filler, more particularly a filler of the siliceous or aluminous type or a mixture of these two types of fillers.

The silica (SiO₂) used may be any reinforcing silica known to a person skilled in the art, in particular any precipitated or pyrogenic silica exhibiting a BET surface and a CTAB specific surface both of less than 450 m²/g, preferably from 30 to 400 m²/g. Highly dispersible precipitated silicas (“HDSs”) are preferred, in particular when the invention is used for the manufacture of tires exhibiting a low rolling resistance; mention may be made, as examples of such silicas, of the Ultrasil 7000 silicas from Degussa, the Zeosil 1165 MP, 1135 MP and 1115 MP silicas from Rhodia, the Hi-Sil EZ150G silica from PPG, the Zeopol 8715, 8745 or 8755 silicas from Huber, or the silicas as described in application WO 03/016387.

The reinforcing alumina (Al₂O₃) preferably used is a highly dispersible alumina having a BET surface ranging from 30 to 400 m²/g, more preferably between 60 and 250 m²/g, a mean particle size at most equal to 500 nm, more preferably at most equal to 200 nm. Mention may in particular be made, as non-limiting examples of such reinforcing aluminas, of the “Baikalox A125” or “CR125” (Baikowski), “APA-100RDX” (Condea), “Aluminoxid C” (Degussa) or “AKP-G015” (Sumitomo Chemicals) aluminas.

Mention may also be made, as other examples of inorganic filler capable of being used in the rubber compositions of the invention, of aluminum (oxide) hydroxides, aluminosilicates, titanium oxides, silicon carbides or nitrides, or all of the reinforcing types as described in applications WO 99/28376, WO 00/73372, WO 02/053634, WO 2004/003067 and WO 2004/056915.

When the treads of the invention are intended for tires with a low rolling resistance, the nonblack reinforcing filler used, in particular if it is a reinforcing inorganic filler, such as silica, preferably has a BET surface of between 60 and 350 m²/g. An advantageous embodiment of the invention consists in using a nonblack filler, in particular a reinforcing inorganic filler, such as silica, having a high BET specific surface within a range from 130 to 300 m²/g, due to the high reinforcing ability recognized for such fillers. According to another preferred embodiment of the invention, use may be made of a nonblack filler exhibiting a BET specific surface of less than 130 m²/g, preferably in such a case at between 60 and 130 m²/g (see, for example, applications WO03/002648 and WO03/002649 mentioned above).

The physical state under which the nonblack reinforcing filler (in particular inorganic filler) is provided is not important, whether it is in the form of a powder, of microbeads, of granules, of beads or any other appropriate densified form. Of course, the term nonblack reinforcing filler is also understood to mean mixtures of different nonblack reinforcing fillers, in particular inorganic fillers, such as highly dispersible siliceous and/or aluminous fillers as defined above.

The person skilled in the art will know how to adjust the level of nonblack reinforcing filler according to the nature of the filler used and according to the type of tire concerned, for example a tire for a motor cycle, for a passenger vehicle or for a utility vehicle, such as a van or heavy-duty vehicle. Preferably, this level of nonblack reinforcing filler, in particular inorganic reinforcing filler, will be chosen between 20 and 200 phr, more preferably between 30 and 150 phr. More preferably still, in particular when the composition of the invention is intended for a passenger vehicle tire tread, the level of this reinforcing filler is chosen to be greater than 50 phr, for example between 60 and 140 phr, in particular within a range from 70 to 130 phr.

In the present account, the BET specific surface is determined in a known way by gas adsorption using the Brunauer-Emmett-Teller method described in “The Journal of the American Chemical Society”, Vol. 60, page 309, February 1938, more specifically according to French standard NF ISO 9277 of December 1996 (multipoint volumetric method (5 points)—gas: nitrogen—degassing: 1 hour at 160° C.—relative pressure range p/po: 0.05 to 0.17). The CTAB specific surface is the external surface determined according to French standard NF T 45-007 of November 1987 (method B).

Finally, the person skilled in the art will understand that carbon black might be used as equivalent filler to the nonblack reinforcing filler described in the present section, provided that the carbon black is covered with a nonblack layer, in particular an inorganic layer, such as silica, comprising, at its surface, functional sites (in particular hydroxyl sites) requiring, in a known way, the use of a coupling agent in order to establish the bonding between the filler (the surface of its particles) and the diene elastomer.

### II-3. Coupling Agent

It should be remembered that a coupling agent, by definition at least bifunctional, can be represented under the simplified general formula “Y-T-X”, in which:
Y represents a functional group (“Y” functional group) capable of being bonded to the nonblack filler, in particular inorganic filler, it being possible for such a bond to be established, for example, between a silicon atom of the coupling agent and the surface hydroxyl (OH) groups of the inorganic filler (for example, the surface silanols, when silica is concerned);
X represents a functional group (“X” functional group) capable of being bonded to the diene elastomer, for example via a sulfur atom;
T represents a divalent group which makes it possible to connect Y and X.

The coupling agents should in particular not be confused with simple covering agents for a nonblack filler, in particular an inorganic filler, which, in a known way, may comprise the Y functional group, active with regard to said filler, but are devoid of the X functional group, active with regard to the elastomer.

Coupling agents (silica/diene elastomer) of variable effectiveness have been described in a very large number of documents and are well known to a person skilled in the art. Use may be made of any coupling agent capable of effectively providing, in diene rubber compositions which can be used in the manufacture of tire treads, the bonding between a reinforcing inorganic filler, such as silica, and a diene elastomer, in particular polyfunctional polyorganosiloxanes or organosilanes carrying X and Y functional groups.

Use is made in particular of silane polysulfides, referred to as “symmetrical” or “unsymmetrical” depending on their specific structure, as disclosed, for example, in applications WO03/002648 and WO03/002649 mentioned above.

“Symmetrical” silane polysulfides corresponding to the following general formula (I):

Z-A-Sₙ-A-Z, (I)

in which:
n is an integer from 2 to 8 (preferably from 2 to 5);
A is a divalent hydrocarbon radical (preferably, C₁-C₁₈ alkylene groups or C₆-C₁₂ arylene groups, more particularly C₁-C₁₀, in particular C₁-C₄, alkylenes, especially propylene);
Z corresponds to one of the formulae below:

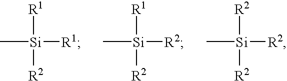

in which:
the R¹ radicals, which are unsubstituted or substituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, in particular C₁-C₄ alkyl groups, more particularly methyl and/or ethyl),
the R² radicals, which are unsubstituted or substituted and identical to or different from one another, represent a hydroxyl, C₁-C₁₈ alkoxyl or C₅-C₁₈ cycloalkoxyl group (preferably a group chosen from hydroxyl, C₁-C₈ alkoxyls and C₅-C₈ cycloalkoxyls, more preferably still a group chosen from hydroxyl and C₁-C₄ alkoxyls, in particular from hydroxyl, methoxyl and ethoxyl),
   are suitable in particular for the implementation of the invention, without the above definition being limiting.

In the case of a mixture of silane polysulfides corresponding to the above formula (I), in particular the usual mixtures available commercially, the mean value of the “n” indices is a fractional number preferably of between 2 and 5, more preferably close to 4. However, the invention can also advantageously be carried out, for example, with silane disulfides (n=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is in particular made, among these compounds, of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂. TESPD is sold, for example, by Degussa under the name Si75 (in the form of a mixture of disulfide (at 75% by weight) and of polysulfides) or also by Witco under the name Silquest A1589. TESPT is sold, for example, by Degussa under the name Si69 (or X50S, when it is supported at 50% by weight on carbon black) or also by Osi Specialties under the name Silquest A1289 (in both cases, conventional mixture of polysulfides with a mean value n which is close to 4).

Mention may also be made, as examples of advantageous coupling agents, of bis(mono(C₁-C₄)alkoxyldi(C₁-C₄)alkylsilylpropyl) polysulfides (in particular disulfides, trisulfides or tetrasulfides), more particularly bis(monoethoxydimethylsilylpropyl) tetrasulfide or disulfide, as disclosed in application WO02/083782 mentioned above.

Mention will in particular be made, as examples of coupling agents other than the abovementioned alkoxysilane polysulfides, of bifunctional polyorganosiloxanes or also of hydroxysilane polysulfides (R²═OH in the above formula I), such as described in applications WO 02/30939 and WO 02/31041.

In the treads according to the invention, the content of coupling agent is preferably between 2 and 15 phr, more preferably between 2 and 12 phr (for example, between 4 and 8 phr). However, it is generally desirable to use as little as possible of it. With respect to the weight of nonblack reinforcing filler, the level of coupling agent typically represents between 0.5 and 15% by weight, with respect to the amount of nonblack filler. In the case, for example, of tire treads for passenger vehicles, the coupling agent is used at a preferred level of less than 12% by weight, indeed even of less than 10% by weight, with respect to this amount of filler.

The coupling agent might be grafted beforehand (via the “X” functional group) to the diene elastomer of the composition of the invention, the elastomer thus functionalized or “precoupled” then comprising the free “Y” functional group for the reinforcing inorganic filler. The coupling agent might also be grafted beforehand (via the “Y” functional group) to the nonblack reinforcing filler, in particular inorganic reinforcing filler, it being possible for the filler thus “precoupled” subsequently to be bonded to the diene elastomer via the free “X” functional group. However, it is preferable, in particular for reasons of better processing of the compositions in the raw state, to use the coupling agent either grafted to the filler or in the free state (i.e., nongrafted).

### II-4. Carbon Black

The rubber composition of the tread of the invention may or may not comprise carbon black. If the latter is present, it is present at a level which is as low as possible, typically of less than 5 phr, preferably of less than 3 phr, this being the case in order to prevent the carbon black from being able to play, due to its known UV-stabilizing properties, an antagonist, and thus undesirable, role with respect to the action of the prophoto-oxidizing agent. For this reason, the level of carbon black is more preferably less than 2 phr.

According to a specific embodiment of the invention, carbon black is used in a very low amount, between 0.05 and 2.0 phr, in particular between 0.05 and 1.5 phr, a narrow concentration range within which the black retains its role of black coloring agent for the composition but no longer fulfils that of UV stabilizer.

All carbon blacks capable of contributing a black coloring to rubber compositions, in particular blacks of the HAF, ISAF or SAF type, known to the person skilled in the art and conventionally used in tires are suitable as carbon blacks. Mention may be made, among the latter, of the reinforcing carbon blacks of the 100, 200 or 300 series (ASTM grades) used in the treads for these tires (for example, N115, N134, N234, N326, N330, N339, N347 or N375) but also those of the non-reinforcing type (as less structured) of the higher 400 to 700 series (for example, the N660, N683 or N772 blacks). Use might also be made, by way of example, of the non-reinforcing blacks, referred to as “ink blacks”, used as black pigments in printing inks or paints.

The carbon blacks can be used in an isolated state, as available commercially, or in any other form, for example as support for some of the rubber industry additives used.

### II-5. Prophoto-Oxidizing Agent

The core of the present invention lies in the use of a prophoto-oxidizing agent in the rubber composition forming at least the surface or outermost surface of the tread of the invention. This agent is intended to promote, to accelerate the process of surface photo-oxidation of the tread when the latter is subjected to exposure to UV-visible radiation.

In a known way, prophoto-oxidizing agents are stable compounds capable of releasing, when they are exposed to light of appropriate wavelength, radical or ionic entities which will promote and accelerate photo-oxidation processes.

These prophoto-oxidizing agents preferably consist of photo-initiators of the radical or cationic type. Such compounds are commonly used in the fields of the photopolymerization of multifunctional monomers, of the surface treatment of materials by protective coatings, of the graphic arts and in electronics for the preparation of microcircuits. In all these applications, the main object is to rapidly obtain highly crosslinked polymers exhibiting high resistance to chemicals and the mechanical properties required (see, for example, J. V. Crivello and K. Dietliker, “Photoinitiators for free radical, cationic and anionic photopolymerisation”, Vol. III, Chemistry and Technology of UV and EB Formulation for Coatings, Inks and Paint, John Wiley and Sons, SITA Technology Limited, 2nd edition, London 1998—E. Chesneau and J. P. Fouassier, “Polymérisation induite sous irradiation laser visible”, [Polymerization induced under laser-visible irradiation], Die Angewandte Makromolekulare Chemie, 135, 1985, p. 41-64).

Mention may be made, as cationic photo-initiators, for example, of onium salts, more particularly sulfonium salts, such as triarylsulfonium salts, or iodonium salts, such as diaryliodonium salts.

Use is preferably made of a photo-initiator of the radical type, more preferably chosen from aromatic ketones, in particular those chosen from the group consisting of benzyl ketals (in particular diketals), benzoins (in particular benzoin ethers), α,α-dialkoxyacetophenones, α-hydroxyalkylphenones, α-amino aromatic ketones (or α-aminoalkylphenones), acylphosphine oxides, benzophenones or thioxanthones in combination with a hydrogen donor (e.g., a tertiary amine), and the mixtures of such compounds.

Mention may in particular be made, as examples of such preferred radical photo-initiators, of:
among benzyl ketals and benzoin ethers: diphenylethanones and their halogenated derivatives (e.g., 2-ethoxy-1,2-diphenylethanone, 2-isopropoxy-1,2-diphenylethanone, 2-isobutoxy-1,2-diphenylethanone, 2-butoxy-1,2-diphenylethanone, 2,2-dimethoxy-1,2-diphenylethanone or 2,2-diethoxy-1,2-diphenylethanone);
among α,α-dialkoxyacetophenones: α,α-diethoxyacetophenone and α,α-di(n-butoxy)acetophenone;
among α-hydroxyalkylphenones: 1-hydroxycyclohexyl phenyl ketone, 2-hydroxy-2-methyl-1-phenylpropan-1-one, 1-[4-(2-hydroxyethoxy)phenyl]-2-hydroxy-2-methylpropan-1-one;
among α-amino aromatic ketones: 2-methyl-1-[4-(methylthio)phenyl]-2-morpholinopropan-1-one, 2-benzyl-2-dimethylamino-1-(4-morpholinophenyl)butan-1-one;
among acylphosphine oxides: (2,4,6-trimethylbenzoyl)diphenylphosphine oxide, (2,4,6-trimethylbenzoyl)phenylphosphinic acid ethyl ester, bis(2,4,6-trimethylbenzoyl)phenylphosphine oxide;
among benzophenones: 2,4,6-trimethylbenzophenone, 4-chlorobenzophenone, 4-methylbenzophenone, [4-(4-methylphenylthio)phenyl]phenyl methanone, 3,3′-dimethyl-4-methoxybenzophenone, methyl 2-benzoylbenzoate, 4-phenylbenzophenone, 4,4′-bis(dimethylamino)benzophenone, 4,4′-bis(diethylamino)benzophenone, benzil benzophenone, 4-phenylbenzophenone;
among thioxanthones: 2-isopropylthioxanthone, 4-isopropylthioxanthone, 2,4-dimethylthioxanthone, 2,4-diethoxythioxanthone, 1-chloro-4-propQxythioxanthone;
among tertiary amines which can be used in combination with benzophenones or thioxanthones: methyldiethanolamine, triethanolamine, ethyl 4-(dimethylamino)benzoate, n-butoxyethyl 4-(dimethylamino)benzoate, isoacryl 4-(dimethylamino)benzoate, 2-(dimethylamino)ethyl benzoate, 1-(4-dimethylaminophenyl)ethanone, 2-ethylhexyl 4-dimethylaminobenzoate.

The above compounds are well known and are available commercially, some sold, for example, by Ciba (Ciba Specialty Chemicals Inc.) under the names “IRGACURE” or “DAROCUR”.

By way of example, bis(2,4,6-trimethylbenzoyl)phenylphosphine oxide, “IRGACURE 819” from Ciba, corresponds to the formula:

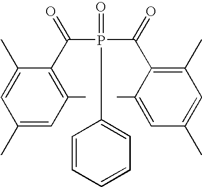

Mention may be made, as other example, of 2,2-dimethoxy-1,2-diphenylethanone, “IRGACURE 651” from Ciba, corresponding to the formula:

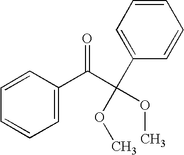

The photo-initiators described above can be used alone, when they are exposed to UV radiation, or, when they are exposed to visible light, in combination with photosensitizers capable of activating their own photo-oxidizing action.

Such photosensitizers are, for example, dyes, such as phthaleins (eosin, erythrosine, ethyl eosin, phloxine, Bengal rose) and thiazines (thionine and methylene blue). If they are used without photosensitizers, the photo-initiators will preferably be chosen in such a way that their UV absorption spectrum and the emission spectrum of the light source (whether natural or artificial) responsible for the photo-oxidation of the tread definitely have a region of overlap.

The person skilled in the art will know how to adjust the amount of prophoto-oxidizing agent in the light of the description and exemplary embodiments which follow. This amount is preferably between 0.1 and 10 phr, more preferably between 0.2 and 5 phr. Below the minima indicated, there is a risk of the targeted technical effect being inadequate, whereas, above the recommended maxima, the costs substantially increase. A reduced amount of between 0.2 and 2 phr has proved to be suitable for a large number of cases.

### II-6. Various Additives

The rubber compositions of the treads in accordance with the invention also comprise all or a portion of the usual additives generally used in elastomer compositions intended for the manufacture of treads, such as, for example, plasticizers or extending oils, where the latter are aromatic or nonaromatic in nature, pigments, protection agents, such as antiozone waxes, chemical antiozonants, antioxidants, which it is preferably to keep present in the body, antifatigue agents, reinforcing or plasticizing resins, methylene acceptors (for example, phenolic novolak resin) or methylene donors (for example, HMT or H3M), such as described, for example, in application WO 02/10269 mentioned above, a crosslinking system based either on sulfur or on sulfur donors and/or on peroxides and/or on bismaleimides, vulcanization accelerators, vulcanization activators.

Preferably, these compositions comprise, as preferred nonaromatic or very slightly aromatic plasticizing agent, at least one compound chosen from the group consisting of naphthenic oils, paraffinic oils, MES oils, TDAE oils, glycerol esters (in particular trioleates), plasticizing hydrocarbon resins exhibiting a high Tg preferably of greater than 30° C., and the mixtures of such compounds. The overall level of such a preferred plasticizing agent is preferably between 15 and 45 phr, more preferably between 20 and 40 phr. Mention will in particular be made, among these plasticizing hydrocarbon resins (it should be remembered that the term “resin” is reserved by definition for a solid compound), of the resins formed of homo- or copolymers of α-pinene, β-pinene, dipentene or polylimonene, C₅ fraction, for example of C₅ fraction/stirene copolymer, which products can be used alone or in combination with plasticizing oils, such as MES or TDAE oils.

Inert fillers (i.e., known reinforcing fillers), such as particles of clay, bentonite, talc, chalk or kaolin, which can be used, for example, in side walls or treads of colored tires, can also be added, depending on the target application, to the reinforcing filler described above, that is to say nonblack reinforcing filler (in particular inorganic filler) plus carbon black, if appropriate.

These compositions can also comprise, in addition to the coupling agents, coupling activators, covering agents (comprising for example, the Y functional group alone) for the nonblack reinforcing filler and more generally processing aids capable, in a known way, by virtue of an improvement in the dispersion of the nonblack filler in the rubber matrix and of a lowering in the viscosity of the compositions, of improving their processing property in the raw state, these agents being, for example, hydrolyzable silanes, such as alkylalkoxysilanes (in particular alkyltriethoxysilanes), polyols, polyethers (for example, polyethylene glycols), primary, secondary or tertiary amines (for example, trialkanolamines), hydroxylated or hydrolyzable POSs, for example α,ω-dihydroxypolyorganosiloxanes (in particular, α,ω-dihydroxypolydimethylsiloxanes).

### II-7. Manufacture of the Treads

Another subject matter of the invention is a process for preparing a tire tread capable of exhibiting, after photo-oxidation at its surface, an improved grip on wet ground, this process being characterized in that at least:
a (at least one) nonblack filler, in particular inorganic filler, as reinforcing filler;
a (at least one) coupling agent intended to provide the bonding between the diene elastomer and said filler;
from 0 to less than 5 phr, preferably from 0 to less than 3 phr, of carbon black;
a (at least one) prophoto-oxidizing agent;
a (at least one) crosslinking system,
   are incorporated, by kneading, into at least a diene elastomer and in that the combined mixture is extruded in the form of a tread.

The rubber compositions are manufactured in appropriate mixers using two successive preparation phases according to a general process well known to the person skilled in the art: a first phase of thermomechanical working or kneading (sometimes described as “non-productive” phase) at high temperature, up to a maximum temperature of between 130° C. and 200° C., preferably between 145° C. and 185° C., followed by a second phase of mechanical working (sometimes described as “productive” phase) at a lower temperature, typically of less than 120° C., for example between 60° C. and 100° C., finishing phase during which the crosslinking or vulcanization system is incorporated.

According to a preferred embodiment of the invention, all the base constituents of the compositions of the treads in accordance with the invention, with the exception of the crosslinking or vulcanization system, namely the nonblack reinforcing filler, the coupling agent, the optional carbon black and the prophoto-oxidizing agent, are intimately incorporated, by kneading, in the diene elastomer during the first “nonproductive” phase, that is to say that at least these various base constituents are introduced into the mixer and that kneading is carried out thermomechanically, in one or more stages, until the maximum temperature of between 130° C. and 200° C., preferably between 145° C. and 185° C., is reached. The total duration of the kneading, in this nonproductive phase, is preferably between 1 and 15 min.

After cooling the mixture thus obtained during the first nonproductive phase, the vulcanization system is then incorporated at low temperature, generally in an external mixer, such as an open mill; the combined mixture is then mixed (productive phase) for a few minutes, for example between 2 and 15 min.

The crosslinking system proper is preferably a vulcanization system based on sulfur and on an accelerator. Use may be made of any compound capable of acting as accelerator of the vulcanization of diene elastomers in the presence of sulfur, in particular those chosen from the group consisting of 2-mercaptobenzothiazyl disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-tert-butyl-2-benzothiazolesulfenamide (abbreviated to “TBBS”), N-tert-butyl-2-benzothiazolesulfenimide (abbreviated to “TBSI”) and the mixtures of these compounds. Preferably, a primary accelerator of the sulfenamide type is used.

Additional to this vulcanization system may be various known secondary accelerators or vulcanization activators, such as zinc oxide, stearic acid, guanidine derivatives (in particular diphenylguanidine), and the like, incorporated during the first non-productive phase and/or during the productive phase. The level of sulfur is preferably between 0.5 and, 3.0 phr and that of the primary accelerator is preferably between 0.5 and 5.0 phr.

The final composition thus obtained is subsequently calendered, for example in the form of a film or a sheet, in particular for laboratory characterization, or else extruded in the form of a rubber profiled element which can be used directly as tire tread.

The vulcanization (or curing) is carried out in a known way at a temperature generally of between 130° C. and 200° C., for a sufficient time which can vary, for example, between 5 and 90 min depending in particular on the curing temperature, the vulcanization system adopted and the vulcanization kinetics of the composition under consideration.

To sum up, the process in accordance with the invention for preparing a tire tread capable of exhibiting, after photo-oxidation of its surface, an improved grip on wet ground, preferably comprises the following stages:
incorporating, in a diene elastomer, in a mixer:
   a nonblack reinforcing filler, in particular an inorganic filler;
   a coupling agent;
   optionally carbon black at a level of zero or less than 5 phr;
   a prophoto-oxidizing agent;
the mixture being kneaded thermomechanically, one or more times, until a maximum temperature of between 130° C. and 200° C. is reached;
cooling the mixture to a temperature of less than 100° C.;
subsequently incorporating:
   a crosslinking system;
kneading the entire mixture until a maximum temperature of less than 120° C. is reached;
extruding or calendering the rubber composition thus obtained in the form of a tire tread.

As explained above and illustrated by the exemplary embodiments which follow, a final stage of photo-oxidation of the surface of the tread confers, on the latter, an improved grip on wet or damp ground.

This additional stage can consist of simple natural exposure to UV-visible radiation or, preferably, of accelerated artificial aging, for example using one or more lamp(s) emitting in the UV-visible region (e.g., mercury vapor lamp, xenon lamp, fluorescent lamp, metal halide lamps), or also in an accelerated photoaging chamber which can comprise one or more of said lamps.

In the process in accordance with the invention, preferably at least one, more preferably all, of the following characteristics is/are satisfied:
the amount of nonblack reinforcing filler, in particular inorganic filler, is between 20 and 200 phr, more preferably between 30 and 150 phr;
the amount of coupling agent is between 2 and 15 phr;
the maximum temperature of thermomechanical kneading is between 145° C. and 185° C.;
the nonblack filler is an inorganic filler, in particular a siliceous or aluminous filler;
the level of optional carbon black is less than 3 phr, more preferably less than 2 phr;
the level of prophoto-oxidizing agent is between 0.1 and 10 phr;
the at least bifunctional coupling agent is an organosilane or a polyorganosiloxane;
the diene elastomer is a butadiene/stirene copolymer (SBR), preferably used as a blend with a polybutadiene.

More preferably, in this process, at least one, more preferably still all, of the following characteristics is/are satisfied:
the amount of nonblack filler, in particular inorganic filler, is greater than 50 phr, in particular between 60 and 140 phr, for example within the range from 70 to 130 phr;
the amount of coupling agent is between 4 and 12 phr, in particular between 3 and 8 phr;
the reinforcing inorganic filler is silica;
the level of carbon black is between 0.05 and 2 phr, more particularly between 0.05 and 1.5 phr;
the level of prophoto-oxidizing agent is between 0.2 and 5 phr, in particular between 0.2 and 2 phr;
the coupling agent is a bis((C₁-C₄)alkoxylsilylpropyl) or bis(hydroxysilylpropyl) polysulfide, in particular disulfide or tetrasulfide;
the SBR is an SBR prepared in solution and the polybutadiene has more than 90% of cis-1,4-bonds.

The rubber compositions described above can constitute all or a portion only of the tread in accordance with the invention.

The invention applies in particular to the cases where these rubber compositions comprising the prophoto-oxidizing agent and the optional carbon black at a zero or very low level, form only a portion of the tread of the invention, in particular the surface part alone of the latter intended to come into contact with the ground during the running of the tire, at some point during the life of the latter, that is to say that said tire is in the used state or in a state of partial wear.

Thus, by way of example, in a tread of the composite type composed of two radially superimposed rubber layers (“cap-base” structure), both intended to come into contact with the road during the running of the tire, the part comprising the prophoto-oxidizing agent and the optional carbon black at a very low level can constitute the radially external layer of the tread in contact with the ground from the beginning of the running of the new tire or, on the other hand, its radially internal layer intended to come into contact with the ground subsequently, in the cases where it would be desired, for example, “to delay” the technical effect provided by the invention, thus compensating for the loss of grip on wet ground resulting from the partial wear of the tread (reduction in depth of relief of the sculpture).

The invention relates to the treads described above and to the tires comprising these treads, both in the raw state (i.e., before curing) and in the cured state (i.e., after crosslinking or vulcanization), before and after photo-oxidation treatment.

### III. EXEMPLARY EMBODIMENTS OF THE INVENTION

### III-1. Preparation of the Rubber Compositions and Treads

The following procedure is adopted for the tests which follow: the reinforcing inorganic filler (silica), the carbon black, the coupling agent, the optional prophoto-oxidizing agent, the diene elastomer or the blend of diene elastomers, and the various other ingredients, with the exception of the vulcanization system, are successively introduced into an internal mixer, filled to 70% and having an initial tank temperature of approximately 60° C. Thermomechanical working (non-productive phase) is then carried out in one stage, which lasts a total of approximately 3 to 4 minutes, until a maximum “dropping” temperature of 165° C. is reached. The mixture thus obtained is recovered, is cooled and then sulfur and sulfenamide accelerator are incorporated on an external mixer (homo-finisher) at 30° C., the combined mixture being mixed (productive phase) for an appropriate time of between 5 and 12 min depending on the case.

The compositions thus obtained are subsequently either calendered, in the form of rubber sheets (thickness of 2 to 3 mm) or thin films for the measurement of their physical or mechanical properties, or extruded in the form of passenger tire treads.

In the examples according to the invention which follow, according to a particularly preferred embodiment, the level of prophoto-oxidizing agent is between 0.2 and 2 phr, more particularly between 0.5 and 1.5 phr; independently, the level of carbon black is preferably between 0.1 and 1.0 phr, more particularly between 0.1 and 0.5 phr.

### III-2. Tests

The tests which follow demonstrate that the introduction of a prophoto-oxidizing agent into the rubber compositions of the treads of the invention, combined with a very low level of carbon black, makes it possible to obtain a substantial increase in the grip on wet roads of said treads, which is reflected by a significant reduction in the braking distances.

### A) Test 1

In this first test, three compositions based on known SBR and BR diene elastomers, reinforced by silica, are first of all compared.

These three compositions, intended to form treads of tires for passenger vehicles, are recorded here as C-1, C-2 and C-3 and differ in the amounts of carbon black and of prophoto-oxidizing agent which they comprise:
C-1 (control): no prophoto-oxidizing agent; 6 phr of carbon black;
C-2 (invention): 1 phr of prophoto-oxidizing agent; 0.3 phr of carbon black;
C-3 (control): no prophoto-oxidizing agent; 0.3 phr of carbon black.

The composition C-1 constitutes the reference, that used in energy-saving Green Tires; it conventionally uses HDS silica as reinforcing inorganic filler and the silane TESPT as coupling agent.

In this composition C-1, the carbon black is used, at the indicated level of 6 phr, both as black pigmenting agent and as UV-stabilizing agent, in accordance with the teaching of the state of the art. In the compositions C-2 and C-3, the carbon black at the very low level used admittedly still fulfils its function of black pigmenting agent but no longer fulfils that of an effective UV-stabilizing agent.

The composition C-2, by virtue of the presence of the prophoto-oxidizing agent (combined with the very low level of carbon black), has a high photo-oxidizability which is assumed a posteriori (this is at the very least what appears to be demonstrated by the following test No. 2) as being favorable to the grip on wet road. The composition C-3 constitutes another control of the test, admittedly comprising a very low level of carbon black but devoid of the prophoto-oxidizing agent.

Tables 1 and 2 give the formulation of the various compositions (table 1—levels of the various products, expressed in phr), their properties before and after curing (20 min at 165° C.).

The examination of the various results from table 2 does not reveal any significant difference between the properties of the three compositions, either from the viewpoint of their processibility in the raw state (Mooney plasticity) or of the mechanical properties (moduli, ratio of the moduli M300/M100, known indicator of the level of reinforcement, breaking properties), in a way which may be described as expected in view of the minimum differences in formulation between the three compositions.

It is in fact only during real running tests carried out on tires that the unexpected result introduced by the invention is revealed, as is clearly confirmed by the test which follows.

### B) Test 2

The compositions C-1, C-2 and C-3 described above are subsequently used as radial carcass passenger tire treads, with a size of 195/65 R15 (speed rate H), conventionally manufactured and in all respects identical apart from the constituent rubber compositions of their tread.

These tires are recorded respectively as P-1, P-2 and P-3. Half of them were subjected to UV aging (natural exposure to ultraviolet and visible radiation) for a duration of 6 hours. For this UV treatment, the tires were exposed externally, in a static position, according to a southerly orientation (Mediterranean site bathed in sunlight with a mean daily temperature of 15° C.), these tires being rotated about their axis by ⅓ of a revolution every two hours, so as to completely expose their tread.

All the tires were subsequently fitted to a passenger vehicle in order to be subjected to the braking test on wet road as described in the preceding section 1-3. The specific conditions of the test are as follows: Renault model Laguna vehicle (front and rear pressure: 2.0 bar); tires tested fitted at the front of the vehicle. The results of the braking test are given in table 3, in relative units, the base 100 being selected for the control tire P-1 before UV aging (restatement: a value of greater than 100 indicates an improved performance).

It is found that only the tire of the invention P-2, and this solely after exposure to UV radiation, exhibits a reduction in the braking distance, by approximately 6%, which is quite significant for the person skilled in the art. The UV aging of 6 hours is, on the other hand, without any effect on the performance of the control tire P-1 or on that of P-2 the tread of which admittedly comprises a very low level of carbon black but is devoid of the prophoto-oxidizing agent.

A series of six successive brakings carried out on the same Laguna vehicle equipped with the “photo-oxidized” tires P-2 demonstrated (see results in table 4) the durability of the technical effect observed, with a mean increase of 6% for each successive braking.

This behavior, which the rubber properties of the preceding test 1 did not allow in any way to be anticipated, is as noteworthy as it is unexpected. This improved grip might be related to an oxidized surface state of the tread, which oxidized surface state is very superficial and localized, favorable to better gripping of the tire to wet ground, a surface state brought about by the presence of the prophoto-oxidizing agent.

This result is furthermore obtained while maintaining the performances of rolling resistance and of wear resistance at the high levels which one is entitled to expect today for rubber compositions based on reinforcing inorganic fillers, such as highly dispersible silicas.

TABLE 1

| | Composition No.: | | |
|---|---|---|---|
| | C-1 | C-2 | C-3 |
| SBR(1) | 70 | 70 | 70 |
| BR (2) | 30 | 30 | 30 |
| Silica (3) | 80 | 80 | 80 |
| Coupling agent (4) | 6.4 | 6.4 | 6.4 |
| Photo-initiator (5) | — | 1 | — |
| Plasticizer (6) | 6 | 6 | 6 |
| Plasticizer (7) | 15 | 15 | 15 |
| Antiozone wax | 1.5 | 1.5 | 1.5 |
| Antioxidant (8) | 1.9 | 1.9 | 1.9 |
| DPG (9) | 1.5 | 1.5 | 1.5 |
| Carbon black (10) | 6 | 0.3 | 0.3 |
| ZnO | 2.5 | 2.5 | 2.5 |
| Stearic acid | 2 | 2 | 2 |
| Sulfur | 1.1 | 1.1 | 1.1 |
| Accelerator (11) | 2 | 2 | 2 |

(1) SBR (expressed as dry SBR) extended with 10% by weight (7 phr) of MES oil (i.e., in total, 77 phr of extended SBR); 25% of stirene, 58% of 1,2-polybutadiene units and 23% of trans-1,4-polybutadiene units (Tg = −24° C.);
(2) BR with 4.3% of 1,2-; 2,7% of trans; 93% of cis-1,4- (Tg = −106° C.);
(3) Silica “Zeosil 1165MP” from Rhodia, “HDS” type (BET and CTAB: approximately 160 m²/g);
(4) Coupling agent TESPT (“Si69” from Rhodia);
(5) Bis(2,4,6-trimethylbenzoyl)phenylphosphine oxide (“Irgacure 819” from Ciba);
(6) MES oil (“Flexon 683”, Exxon Mobil);
(7) Plasticizing hydrocarbon resin with a high Tg (poly-α-pinene “R2495”, Hercules);
(8) N-(1,3-Dimethylbutyl)-N-phenyl-paraphenylenediamine (“Santoflex 6-PPD” from Flexsys);
(9) Diphenylguanidine (“Perkacit DPG” from Flexsys);
(10) Carbon black N234;
(11) N-Cyclohexyl-2-benzothiazylsulfenamide (“Santocure CBS” from Flexsys).

TABLE 2

| | Composition No.: | | |
|---|---|---|---|
| | C-1 | C-2 | C-3 |
| Properties before curing: | | | |
| Mooney (MU) | 102 | 93 | 95 |
| Properties after curing: | | | |
| M10 (MPa) | 6.5 | 5.7 | 6.0 |
| M100 (MPa) | 2.1 | 1.8 | 1.9 |
| M300 (MPa) | 2.5 | 2.1 | 2.2 |
| M300/M100 | 1.2 | 1.2 | 1.2 |
| Breaking stress (MPa) | 20.4 | 21.8 | 21.3 |
| Elongation at break (%) | 471 | 566 | 516 |

TABLE 3

| | Tire: | | |
|---|---|---|---|
| | P-1 (control) | P-2 (invention) | P-3 (control) |
| Before UV aging | 100 | 100 | 100 |
| After UV aging | 100 | 106 | 100 |

Braking performance (1st braking) on wet road (in relative units)

TABLE 4

| | Braking No. | | | | | |
|---|---|---|---|---|---|---|
| | 1 | 2 | 3 | 4 | 5 | 6 |
| (Tire P-2 after UV aging): | 106 | 104 | 108 | 108 | 106 | 104 |

Successive brakings on wet roads (in relative units)

1. A tire tread comprising a rubber composition based on at least a diene elastomer, a nonblack reinforcing filler, a coupling agent providing the bonding between the diene elastomer and said filler, and optionally carbon black, said composition being characterized in that it additionally comprises a prophoto-oxidizing agent and in that its level of carbon black is zero or less than 5 phr (parts by weight per hundred parts of elastomer).

2. The tread according to claim 1, the prophoto-oxidizing agent being chosen from the group consisting of the photo-initiators of radical or cationic type.

3. The tread according to claim 2, the prophoto-oxidizing agent being a cationic photo-initiator.

4. The tread according to claim 3, the prophoto-oxidizing agent being an onium salt.

5. The tread according to claim 2, the prophoto-oxidizing agent being a radical photo-initiator.

6. The tread according to claim 5, the radical photo-initiator being an aromatic ketone.

7. The tread according to in claim 6, the aromatic ketone being chosen from the group consisting of benzyl ketals, benzoins, -dialkoxyacetophenones, -hydroxyalkylphenones, -aminoalkylphenones, acylphosphine oxides, benzophenones or thioxanthones in combination with a hydrogen donor, and the mixtures of such compounds.

8. The tread according to claim 1, the diene elastomer being chosen from the group consisting of polybutadienes, synthetic polyisoprenes, natural rubber, butadiene copolymers, isoprene copolymers and the blends of these elastomers.

9. The tread according to claim 1, the nonblack reinforcing filler being an inorganic filler.

10. The tread according to in claim 9, the inorganic reinforcing filler being a siliceous or aluminous filler.

11. The tread according to claim 1, the level of nonblack reinforcing filler being between 20 and 200 phr.

12. The tread according to claim 11, the level of nonblack reinforcing filler being between 30 and 150 phr.

13. The tread according to claim 1, the coupling agent being an at least bifunctional silane or polysiloxane.

14. The tread according to claim 1, the level of coupling agent being between 2 and 15 phr.

15. The tread according to claim 1, the level of carbon black being less than 3 phr.

16. The tread according to claim 15, the level of carbon black being less than 2 phr.

17. The tread according to claim 1, the level of prophoto-oxidizing agent being between 0.1 and 10 phr.

18. The tread according to claim 17, the level of prophoto-oxidizing agent being between 0.2 and 5 phr.

19. The tread according to claim 18, the level of prophoto-oxidizing agent being between 0.2 and 2 phr.

20. The tread according to claim 1, the rubber composition additionally comprising a photosensitizer.

21. The tread according to claim 20, the photosensitizer being chosen from phthaleins and thiazines.

22. The tread according to claim 8, the diene elastomer being a butadiene/styrene copolymer (SBR).

23. The tread according to claim 22, the SBR being used as a blend with a polybutadiene.

24. (canceled)

25. A tire comprising a tread in accordance with claim 1.

26. A process for preparing a tire tread exhibiting, after photo-oxidation of its surface, an improved grip on wet road, characterized in that there are incorporated in at least a diene elastomer, by kneading, at least a nonblack filler as reinforcing filler, a coupling agent providing the bonding between the diene elastomer and said filler, optionally carbon black at a level of less than 5 phr, a prophoto-oxidizing agent and a crosslinking system and in that the combined mixture is extruded in the form of a tread.

27. The process according to claim 26, comprising the following stages:
incorporating, in the diene elastomer, in a mixer:
the nonblack reinforcing filler;
the coupling agent;
the optional carbon black at a level of less than 5 phr;
the prophoto-oxidizing agent;
the mixture being kneaded thermomechanically, in one or more stages, until a maximum temperature of between 130° C. and 200° C. is reached;
cooling the mixture to a temperature of less than 100° C.;
subsequently incorporating:
the crosslinking system;
kneading the entire mixture until a maximum temperature of less than 120° C. is reached;
extruding or calendering the rubber composition thus obtained in the form of the tire tread.

28. The process according to claim 26, the prophoto-oxidizing agent being chosen from the group consisting of photo-initiators of radical or cationic type.

29. The process according to claim 28, the prophoto-oxidizing agent being a radical photo-initiator.

30. The process according to claim 29, the radical photo-initiator being an aromatic ketone.

31. The process according to claim 30, the aromatic ketone being chosen from the group consisting of benzyl ketals, benzoins, -dialkoxyacetophenones, -hydroxyalkylphenones, -aminoalkylphenones, acylphosphine oxides, benzophenones or thioxanthones in combination with a hydrogen donor, and the mixtures of such compounds.

32. The process according to claim 26, the diene elastomer being chosen from the group consisting of polybutadienes, synthetic polyisoprenes, natural rubber, butadiene copolymers, isoprene copolymers and the blends of these elastomers.

33. The process according to claim 26, the nonblack reinforcing filler being an inorganic filler.

34. The process according to claim 26, the level of carbon black being less than 3 phr.

35. The process according to claim 34, the level of carbon black being less than 2 phr.

36. The process according to claim 26, the level of prophoto-oxidizing agent being between 0.1 and 10 phr.

37. The process according to claim 36, the level of prophoto-oxidizing agent being between 0.2 and 5 phr.

38. The process according to claim 37, the level of prophoto-oxidizing agent being between 0.2 and 2 phr.

39. The process according to claim 26, characterized in that it is supplemented by a stage of photo-oxidation of the surface of the tread.

40. The process according to claim 39, the photo-oxidation stage consisting of an accelerated aging.

41. The process according to claim 40, the accelerated aging being carried out using one or more lamps emitting in the UV-visible region.
